(19) United States
(12) Patent Application Publication
(10) Pub. No.: US 2014/0178792 A1
(43) Pub. Date: Jun. 26, 2014

(54) Electrochemical Device Including Amorphous Metal Oxide on Graphene

(71) Applicant: FORD GLOBAL TECHNOLOGIES LLC, Dearborn, MI (US)

(72) Inventors: Jun Yang, Bloomfield Hills, MI (US); Patrick Pietrasz, Southgate, MI (US); Chunchuan Xu, Bloomfield Hills, MI (US); Richard E. Soltis, Saline, MI (US); Mark S. Sulek, Sterling Heights, MI (US); Mark S. Ricketts, Windsor (CA)

(73) Assignee: FORD GLOBAL TECHNOLOGIES LLC, Dearborn, MI (US)

(21) Appl. No.: 13/721,883

(22) Filed: Dec. 20, 2012

(51) Int. Cl. H01M 4/90

(52) U.S. Cl. CPC H01M 4/9016
USPC 429/482; 429/528; 204/192.17

(57) ABSTRACT

In one or more embodiments, an electrochemical device includes a catalyst promoter including an amorphous metal oxide, the amorphous metal oxide being of an amount greater than 50 percent by weight of the total weight of the substrate, and a substrate including graphene and supporting the substrate.

### TECHNICAL FIELD

The present invention relates to an electrochemical device including an amorphous metal oxide on graphene and a method of making the same.

### BACKGROUND

Fuel cells are potential low emission energy sources to power vehicles. Existing fuel cell catalysts include platinum (Pt) nano-particles on carbon support. These catalysts are susceptible to catalyst dissolution and/or agglomeration, often require excessive precious catalyst loading, and therefore are cost-inefficient in general.

### SUMMARY

In one or more embodiments, an electrochemical device includes a catalyst promoter including an amorphous metal oxide, the amorphous metal oxide being of an amount greater than 50 percent by weight of the total weight of the catalyst promoter, and a substrate including graphene and supporting the substrate. A total contacting surface between the substrate and the catalyst promoter may be less than an external surface of the base. The total contacting surface may be 25 to 75% of the external surface of the base. The amorphous metal oxide may be of a general formula of MOₓ, with x being sub-stoichiometric relative to O such that MOₓ is oxygen deficient. The catalyst promoter may be configured as a number of spaced apart discontinuities of the amorphous metal oxide. An average diameter of the number of spaced apart discontinuities may be 2 to 3 nanometers.

The electrochemical device may further include a catalyst supported on the catalyst promoter and including a noble metal, the catalyst promoter being disposed between the catalyst and the base. The catalyst may contact at least one of the amorphous metal oxide and graphene. The amorphous metal oxide may contact the graphene.

The electrochemical device may further include a proton exchange membrane disposed next to the catalyst such that the catalyst is positioned between the catalyst promoter and the proton exchange membrane.

### BRIEF DESCRIPTION OF THE DRAWINGS

FIG. 1A illustratively depicts a perspective view of a fuel cell according to one or more embodiments of the present invention;

FIG. 1B illustratively depicts a perspective view of an cathode referenced in FIG. 1A;

FIG. 1C illustratively depicts a plan view of a discontinuous catalyst promoter layer according to one embodiment;

FIG. 2A depicts the CV of 2.4 nm Pt on graphene at 1600 rpm with a scan rate of 200 mV/s in 0.1 M HClO₃(a), wherein the blue line present the CV of the starting ECSA and the red line represents the CV after 10 cycle of ORR measurement;

FIG. 2B depicts the ORR cycle test after the ECSA measurement for the red line sample reported in FIG. 2A for a total of 200 cycles;

FIG. 3A depicts the STEM image (HAADF) of 2.4 nm Pt supported on a hybrid catalyst promoter of amorphous conductive metal oxide and graphene;

FIG. 3B depicts the SAED results which indicate that the NbOₓ as deposited is amorphous and the Pt is poly-crystalline;

FIG. 3C depicts the crystal (111) orientation of the Pt along the edge surfaces as deposited on graphene;

FIG. 4A depicts the ECSA result of the 2.4 nm Pt on 3.0 nm amorphous NbOₓ on graphene;

FIG. 4B depicts the obtained ORR activities, indicating ORR activities in kinetic current of 2400 μA/cm²-Pt, very close to that of the bulk-Pt, with highly acceptable stability; and

FIG. 5 illustratively depicts an example sputtering process referenced in the Example.

### DETAILED DESCRIPTION

Reference will now be made in detail to compositions, embodiments, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Electrochemical devices such as fuel cells employ certain catalysts to facilitate electrochemical reactions. Platinum is a widely-used catalyst in these devices. In order for catalysts such as platinum to function effectively a suitable substrate is used to support and enhance the catalytic activities of the catalyst.

Graphene exhibits some unique and favorable properties in strength, conductivity and resistance to oxidation. It has been found, according to one or more embodiments of the present invention, the beneficial properties of the graphene may be closely presented with the concurrent employment of an amorphous metal oxide supported thereupon. As is detailed herein elsewhere, catalyst atoms can be deposited via sputtering and the deposited catalyst atoms can be in contact with both the amorphous metal oxides and the graphene. In this configuration, the direct contact between graphene with the catalyst atoms would help to present the catalyst atoms in a catalytically more active orientation, for instance, with (111), (001) and/or (100) crystalline facets. Favorable electrocatalytic activities may further be enhanced possibly via the d-band integrations between the catalyst atoms and the amorphous metal oxides. The direct contact between the graphene and the catalyst atoms is also beneficial as these regions of contact provides desirable electrical conductivity and makes up any loss in electrical conductivity due to the presence of the amorphous metal oxides which are comparably less electrically conductive than graphene. By way of example, electrical resistivity of amorphous metal oxide is about 1 to 5×10⁻⁵ Ω·cm, which is an order of magnitude higher than graphene of 10⁻⁶ Ω·cm.

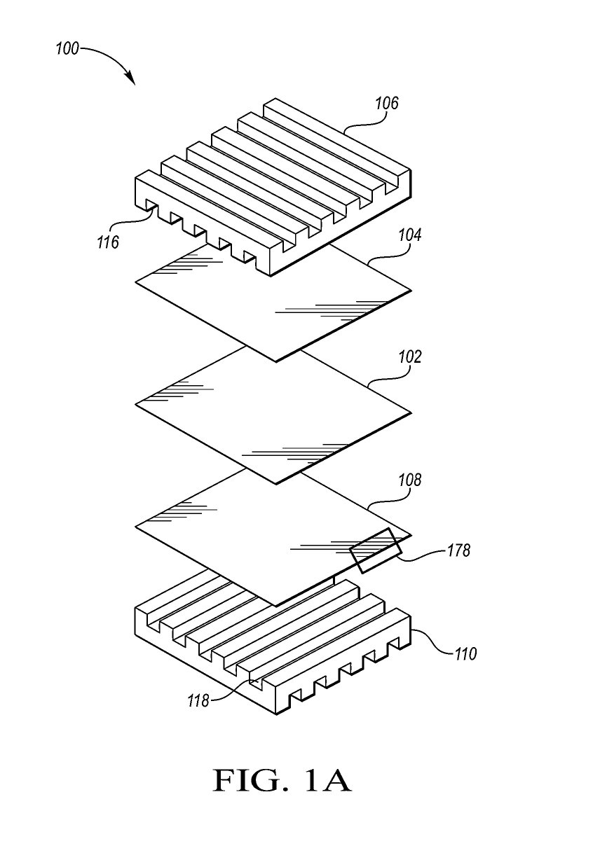

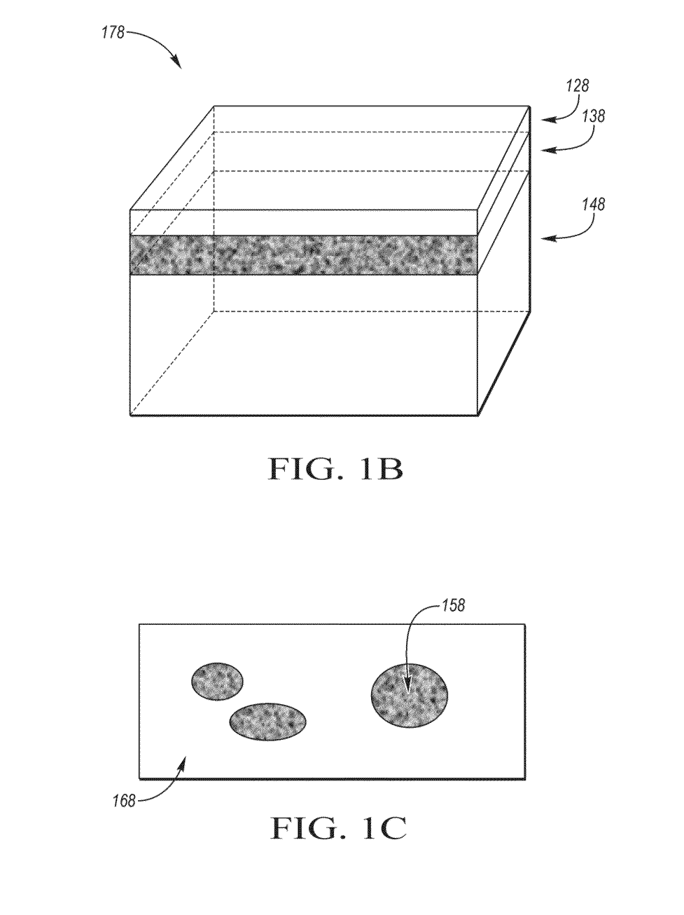

For the purpose of illustration, an exemplary electrochemical device such as a fuel cell 100 is schematically depicted in FIG. 1A. The fuel cell 100 includes a pair of bi-polar plates 106, 110 having grooves 116, 118 formed at a predetermined interval on both sides of each of the bi-polar plates 106, 110. The fuel cell 100 also includes an ionic exchange membrane 102 disposed between the bi-polar plates 106, 110, a first electrode such as an air electrode 108 disposed between the ionic exchange membrane 102, 110 and the bi-polar plate 110, and a second electrode such as a fuel electrode 104 disposed between the ionic exchange membrane 102 and the bi-polar plate 106.

The bi-polar plates 106 and 110 are for electrically connecting the air electrode 108 and the fuel electrode 104, and preventing fuel and air (an oxidizer) from being mixed. The grooves 116 and 118 are used as fuel and air passages in the cells connected end to end.

In operation, air is brought into contact with the air electrode 108, and hydrogen gas is brought into contact with the fuel electrode 104 as fuel, which results in separation of the hydrogen gas into hydrogen ions and electrons on the fuel electrode 104. These hydrogen ions are combined with water to move to the air electrode 108 side in the ionic exchange membrane 102, while the electrons move via an external circuit (not shown) to the air electrode 108 side. In the air electrode 108, oxygen, electrons, and hydrogen ions react to generate water.

FIG. 1B illustratively depicts a portion 178 of the electrode 108, the portion 178 including a catalyst 128 supported on a catalyst promoter 138, the catalyst 128 including a noble metal, which is then in turn supported on a substrate 148. The catalyst promoter 138 includes an amorphous metal oxide of an amount greater than 50 percent by weight of the total weight of the catalyst promoter 138. In certain instances, the amorphous metal oxide may be of an amount of greater than 60, 70, 80, 90, or 99 percent by weight of the total weight of the substrate.

The catalyst promoter 138, the catalyst 128 and the substrate 148 can all be in a layer-to-layer configuration and in full contact with each other, but they do not have to be. For instance, and as depicted in FIG. 1C, the catalyst promoter 138 may be configured as a number of patches or discontinuities 158, at least a portion of which being spaced apart from each other. In this configuration, the catalyst promoter 138 only covers a portion of an external surface 168 of the substrate 148, with the level of coverage being from 25 to 75%, 30 to 70%, 35 to 65% or 40 to 60%. This configuration may be beneficial in that the discontinuities 158 may form a seeding plate to facilitate a desirable growth the catalyst 128. The desirable growth may be a growth of the catalyst 128 in the crystalline (111), (110) and (001) orientation. Without wanting to be limited to any particular theory, it is believed that some remaining local atomic (short-range) order of the amorphous metal oxides can facilitate the d-band interaction between the catalyst atoms and the substrate such that electro-catalytic activities can be enhanced.

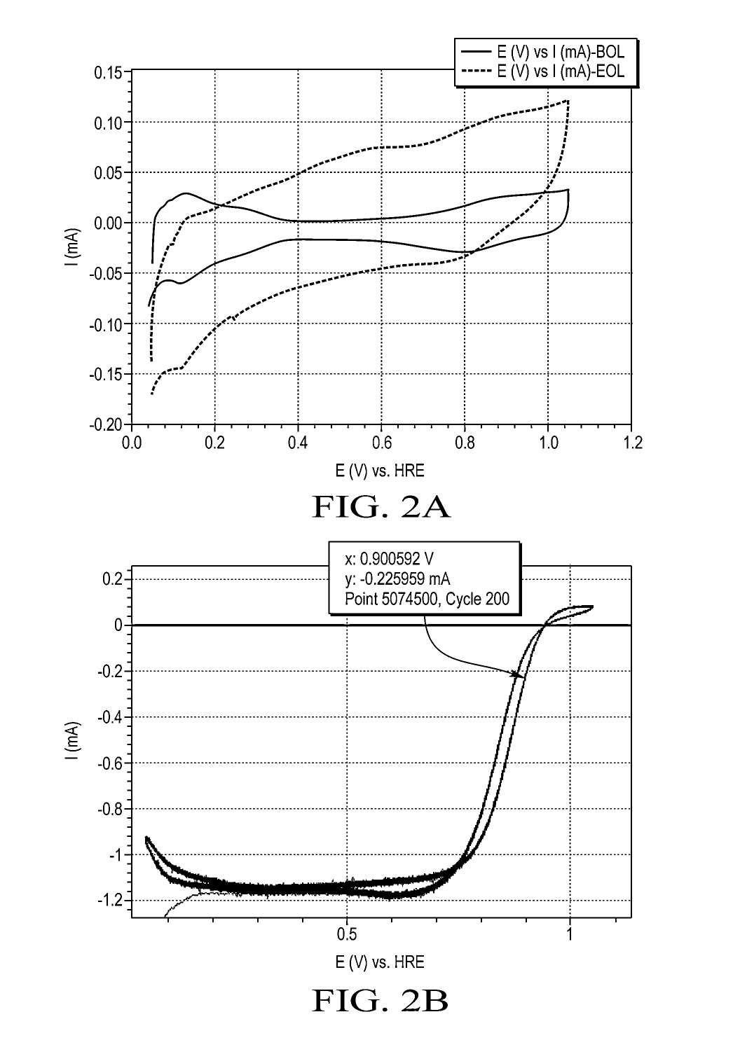

Moreover, and as is discussed in the Example in relation to FIG. 2D, the catalyst 128 may form a percolated two dimensional network when coming in contact with the discontinuities 158 via sputtering deposition. Without wanting to be limited to any particular theory, it is believed that the discontinuities 158 of amorphous metal oxide favorably position the catalyst atoms as deposited, and facilitate the oriented crystalline growth of the deposited catalyst atoms and hence the much enhanced catalytic activity and stability.

As mentioned herein, the substrate 148 includes graphene and may be entirely formed of graphene. In certain instances, the substrate 148 includes at least 50 percent, 60 percent, 70 percent, 80 percent, 90 percent, or 99 percent by weight of graphene. With this configuration, a portion of the catalyst 128 can be in direct contact with the substrate 148 and with graphene in particular.

Graphene may be formed from carbon, with carbon atoms arranged in a one-atom thick sheet with a hexagonal pattern. The term “graphene” or “graphene layer” refers to materials that contain at least some individual layers of single layer sheets. Graphene is usually light with a density of about 0.8 mg/m² sheet. The carbon-carbon bond length in graphene is about 0.14 nm. Graphene sheets may stack to form graphite with an interplanar spacing of about 0.34 nm.

Graphene may be formed by any suitable method. One non-limiting example of the forming method which involves chemical reduction of graphene oxide can be found in “Electronic Transport Properties of Individual Chemically Reduced Graphene Oxide Sheets”, Navarro et al., Nano Lett. 2007, 7, 3499-3503. Dependent upon the source of the starting material, graphene as produced may contain a relatively small amount of graphene oxide.

To maximize the conductivity of the graphene, carbon-to-oxygen (C:O) ratio and the specific surface area of graphene may be used as a proxy to measure the relative abundance of high conductivity single-sheets in a given sample. Without wanting to be limited to any particular theory, it is believed that the C:O ratio is a good measure of the degree of “surface functionalization” which affects conductivity, and the surface area conveys the percentage of single-sheet graphene in the synthesized powder.

The discontinuities 158 may be of any suitable dimensions. The discontinuities 158 may be provided with an average diameter 0.5 to 10 nanometers, 1 to 7 nanometers, or 2 to 3 nanometers. The catalyst promoter 138 and the discontinuities 158 in particular may be provided with an average thickness of less than 50 nanometers, 40 nanometers or 30 nanometers. In certain instances, the average thickness is 0.5 to 10 nanometers, 1 to 7 nanometers, or 2 to 3 nanometers. These thickness values are relatively small and can only be formed through certain methods. As will be detailed herein elsewhere, sputtering is one of such methods. These parameters may not necessarily affect the electronic conductivity of the MOₓ as deposited, yet may affect the morphology and interaction with the catalyst to be deposited.

In certain instances, the substrate 148 includes less than 50 percent, 40 percent, 30 percent 20 percent, 10 percent, 5 percent, 1 percent, or 0.1 percent by weight of any metals. This may become important as presence of metals in the substrate 148 does not provide added value to the electrochemical device 100. Rather, the present of metals in the substrate 148 may impart unnecessary weight and sensitivity to corrosion particularly within the context of a fuel cell.

In one or more embodiments, the term “amorphous metal oxides” refers to those metal oxides having at least one of the following features: being substantially without grain boundaries, with local/short-range atomic arrangement, and being substantially without long-range order of atomic arrangement characteristic of a crystal, such that these metal oxides are less likely to be transformed into crystalline structure. Amorphous conductive metal oxides are resistant to oxygen incorporation, thus preserving the structural stability and electronic conductivity of as-made materials.

Another benefit of the amorphous structure is that the metal oxides, when in amorphous state, may be configured into thin films with relatively greater ease than their crystalline counterpart.

In contrast, a crystal or crystalline solid is a solid material whose constituent atoms, molecules, or ions are arranged in an ordered pattern extending in all three spatial dimensions. In addition to their microscopic structure, large crystals are usually identifiable by their macroscopic geometrical shape, consisting of flat faces with specific, characteristic orientations. The scientific study of crystals and crystal formation is known as cyrstallography. The process of crystal formation via mechanisms of crystal growth is called crystallization or solidification. Common crystals include snowflakes, diamonds, and table salt; however, most common inorganic solids are polycrystals.

The amorphous metal oxide may be of a general formula of MOₓ, with x being sub-stoichiometric relative to oxygen such that MOₓ is oxygen deficient. With MOₓ being sub-stoichiometric relative to the oxygen atom, the structures of the amorphous metal oxides MOₓ contain oxygen vacancies, wherein some of the lattice sites which would have been occupied by oxygen atoms are vacant. This would contribute to higher metallic conductivity of a particular grain of sub-stoichiometric MOₓ due to the relatively higher fraction of M-M bonds verse M-O in the sub-stoichiometric oxide versus the stoichiometric oxide.

While oxides of certain readily available metals can be configured into their amorphous, conductive state in forming the catalyst promoter 138, certain parameters may be considered in designing the substrate. One such consideration is that the substrate cannot be completely insulating, which may retard the electrochemical reactions. Another consideration is the cost such that the material and manufacturing cost for producing the substrate should not be a limiting factor in formulating the entire electrochemical device. As is detailed herein elsewhere, the amorphous metal oxides are believed to be relatively more resistant to transformation into an insulating state and are relatively more stable to maintain at a conductive state.

Non-limiting examples of the metal M in the amorphous conductive MOₓ include Sc, Ti, Cr, Y, Zr, Nb, Mo, Ru, Rh, Pd, Hf, Ta, W, Re, Ir, Pt, Au or alloys and combinations thereof.

As detailed herein else, x is sub-stoichiometric relative to the oxygen atom. By way of example, and in the instance of Nb, crystalline NbO and NbO₂ are electronically conducting. In contrast, crystalline Nb₂O₅ is electronically insulating which should be avoided. However, amorphous metal oxides NbOₓ are electronically conducting in a wide range of x value. A stable, conductive amorphous metal oxide might be able to maintain the beneficial effects of a metal oxide support on Pt activity without loss of support conductivity and stability due to support oxidation. Therefore, in the instance of NbOₓ, the presence of Nb₂O₅ should be avoided, and when incidentally included, Nb₂O₅ should be in an amount of no more than 5%, 2.5%, 1% or 0.5% of the total weight of the catalyst promoter 138.

The catalyst promoter 138 includes less than 20 percent, 10 percent, 5 percent, 1 percent, 0.1 percent, or 0.01 percent by weight of any impurities. The impurities may include anything other than the targeted amorphous metal oxide. In certain instances, the impurities may be in the form of an incidental presence of crystalline metal oxides. In certain particular instance, a weight ratio of incidentally present crystalline metal oxide relative to the targeted amorphous metal oxide is less than 0.05, 0.01 or 0.001 such that the catalyst promoter 138 can be considered as substantially free from any incidentally present crystalline metal oxide. Therefore, in the instance of amorphous NbOₓ, the presence of crystalline Nb₂O₅ should be avoided, and when incidentally included, Nb₂O₅ should be in an amount of no more than 20, 10, 5, 1, 0.1 or 0.01 weight percent of the total weight of the catalyst promoter 138.

In certain other instances, the impurities may be in the form of an incidental presence of any noble metals and/or salts and alloys thereof, such as platinum, ruthenium, rhodium, palladium, silver, gold, iridium, and osmium. The catalyst promoter 138 does not necessarily include any noble metals from the perspectives of cost effectiveness. To the extent that the catalyst promoter 138 and the catalyst 128 are in contact, no chemical bond such as metallic bond formation is intended between the metal M in the catalyst promoter 138 and the noble metal in the catalyst 128.

Without wanting to be limited to any particular theory, it is believed that relatively low impurity rate detailed herein above is effectuated via the use of sputtering technologies operated at certain suitable parameters. The sputtering can be operated with a clean source for M, a clean source for 0, and with the assistance of a vacuum. As a result, the amorphous metal oxide as formed from the sputtering can be of a relatively high purity. This benefit is in direct comparison to some other methods where metal oxides are formed via a wet liquid application coated as a layer which inevitably includes uncontrollable amount of impurities, let alone controllable presence of amorphous metal oxide and controllable absence of crystalline metal oxide.

The catalyst promoter 138 can be prepared by physical vapor deposition (PVD) such as sputtering, sol-gel processing, chemical vapor deposition (CVD), and atomic layer deposition (ALD). ALD in general may make use of various oxygen sources for the decomposition of precursor compounds. Both water and oxygen may be used in ALD processes.

Sputtering is a process whereby atoms are ejected from a solid source material via bombardment exerted by energetic particles. It happens when the kinetic energy of the incoming particles is much higher than conventional thermal energies. Physical sputtering may be driven by momentum exchange between the ions and atoms in the materials, due to collisions. The primary particles for the sputtering process can be supplied in a number of ways, for example by a plasma, an ion source, an accelerator or by a radioactive material emitting alpha particles.

Preferential sputtering can occur at the start when a multicomponent solid source material is bombarded and there is no solid state diffusion. If the energy transfer is more efficient to one of the source components, and/or it is less strongly bound to the solid, it will sputter more efficiently than the other. If in an AB alloy the component A is sputtered preferentially, the surface of the solid will, during prolonged bombardment, become enriched in the B component thereby increasing the probability that B is sputtered such that the composition of the sputtered material will be AB. This is useful to form the MOₓ when M of the MOₓ includes two or more elements.

To ensure the metal oxides contained within the catalyst promoter 138 are amorphous, certain operation parameters should be controlled. For instance, the sputtering should be conducted at a temperature no greater than the crystallization temperature of the metal oxide MOₓ to avoid any formation of the crystalline structures of the metal oxides. Taking NbOₓ for an example, the sputtering should be carried out at below 700° C. at all times.

With the sputtering, the amorphous metal oxides may form into spaced apart discontinuities, such as the ones detailed in FIG. 1C. The morphologies of these discontinuities may be evaluated via transmission electron microscopy (TEM).

Transmission electron microscopy (TEM) is a microscopy technique whereby a beam of electrons is transmitted through an ultra thin specimen, interacting with the specimen as it passes through. An image may be formed from the interaction of the electrons transmitted through the specimen. TEMs are capable of imaging at a significantly higher resolution than light microscopes. This enables the instrument's user to examine fine detail—even as small as a single column of atoms, which is tens of thousands times smaller than the smallest resolvable object in a light microscope.

To obtain the metal oxide as deposited being amorphous and conductive, certain operation parameters should be considered. These parameters may include type of the starting materials, the oxygen to argon ratios and deposition temperatures. By way of example, the deposition temperature and/or the material temperature are to be maintained below the re-crystallization temperature at all times and under all operational conditions. If the material temperature exceeds the re-crystallization temperature, the amorphous material crystallizes, and the favorable amorphous properties are lost. Moreover, it is believed that if a metal oxide stays amorphous throughout an entire temperature window needed for the fuel cell operation, the metal oxide will stay conductive throughout.

Another consideration is the oxygen content in the gas mixture for forming the plasma in the sputtering process. The gas mixture may include an inert gas in addition to oxygen. Argon gas is a non-limiting example of the inert gas. When oxygen and argon are used, oxygen to argon volume ratio should be kept at 10 to 30%. This ratio is beneficial in that the amount of oxygen is controlled such that the metal oxides as formed via the sputtering may be oxygen deficient. As mentioned herein elsewhere, the amorphous metal oxide with oxygen being deficient is electrically more conductive than a counterpart that is not oxygen deficient.

Without wanting to be limited to any particular theory, it is believed that when the substrate temperature is appropriate, that is above 300° C. but below the crystallization temperature of about 700° C., the Pt deposited on the amorphous conductive metal oxide forms a 2-D percolated Pt network. The obtained Pt based ORR catalyst on conductive amorphous metal oxide on graphene substrate exhibits bulk-like ORR activity.

Yet another consideration for carrying out the sputtering is the vacuum level. The vacuum level may be used to control the cleanliness of the MOₓ layer as deposited and hence the nucleation of the individual deposition layers.

The catalyst promoter may be formed via sputtering with a source of MO_{y} and a source of an inert gas separately provided from the source of MO_{y}, wherein y may the same as or different from x. By way of example, and when M is Nb, MO_{y} may be Nb₂O₅ with y being 2.5 and MOₓ may be NbO or NbO₂ or any other compositions with x being of a value between 0.9 and 2.2.

Alternatively, the sputtering may be carried out with a source of neat metal M and a source of a mixed gas separately provided from the source of neat metal M, the mixed gas including oxygen and an inert gas. The inert gas is used to form a plasma for the sputtering process. Oxygen and M are separately sputtered with the plasma formed by the inert gas to form a desirable amorphous metal oxide on a receiving surface. In forming the substrate, the sputtering may be carried out at an oxygen to inert gas ratio of 10 to 30 percent by volume.

The amorphous metal oxides may be detected and analyzed using TEM or high resolution transmission electron microscopy (HRTEM) coupled with selected angle electron diffraction (SAED). SAED may be performed with a TEM in diffraction mode.

Selected area (electron) diffraction (SAED) is a crystallographic experimental technique that can be performed inside a TEM. In a TEM, a thin crystalline specimen is subjected to a parallel beam of high-energy electrons. Because the wavelength of high-energy electrons is a few thousandths of a nanometer, and the spacing between atoms in a solid is about a hundred times larger, the atoms act as a diffraction grating to the electrons, which are diffracted. That is, some fraction of them will be scattered to particular angles, determined by the crystal structure of the sample, while others continue to pass through the sample without deflection. As a result, the image on the screen of the TEM will be a series of spots—the selected area diffraction pattern, each spot corresponding to a satisfied diffraction condition of the sample's crystal structure.

SAD is referred to as “selected” because the user can easily choose from which part of the specimen to obtain the diffraction pattern. This is important, for example, in polycrystalline specimens. If more than one crystal contributes to the SADP, it can be difficult or impossible to analyze. As such, it is useful to select a single crystal for analysis at a time. It may also be useful to select two crystals at a time, in order to examine the crystallographic orientation between them.

As a diffraction technique, SAD can be used to identify crystal structures and examine crystal defects. It is similar to XRD, but unique in that areas as small as several hundred nanometers in size can be examined, whereas XRD typically samples areas several centimeters in size.

In certain instances, sputtering is a method preferred over ALD in depositing and forming onto graphene a catalyst promoter including an amorphous metal oxide MOₓ. This is at least because ALD does not readily provide a mechanism to ensure the formed MOₓ is oxygen deficient to ensure the MOₓ is conductive and amorphous.

Having generally described several embodiments of this invention, a further understanding can be obtained by reference to certain specific examples which are provided herein for purposes of illustration only and are not intended to be limiting unless otherwise specified.

### EXAMPLE

In this example, the ORR (oxygen reduction reaction) activity of a sample catalyst formed of 2.4 nm of Pt magnetron sputtered onto amorphous NbOₓ supported on a graphene sheet is compared to the ORR activity of a control catalyst formed of a 2.4 nm of Pt magnetron sputtered directly onto a graphene sheet.

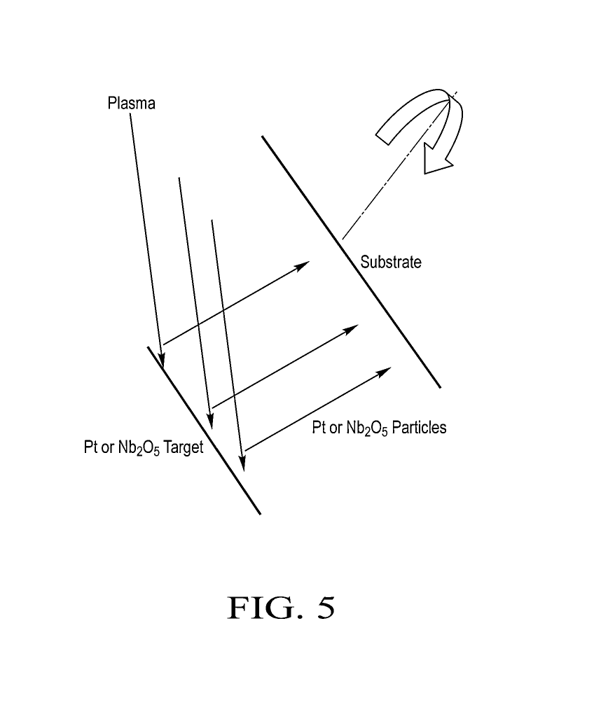

FIG. 5 illustratively depicts an example sputtering process used for forming the Pt catalyst and the amorphous NbOₓ. As illustratively depicted in FIG. 5, the plasma formed from Ar and/or O₂ knocks out the Nb source target; the resultant Nb target is then released and flies towards and stick onto the base of graphene sheet.

FIG. 2A depicts the CV (cyclic voltammetry) of the control catalyst of 2.4 nm Pt on graphene at 1600 rpm with a scan rate of 200 mV/s in 0.1 M HClO₃, wherein line 202 presents the CV of the starting ECSA (electron spectroscopy for chemical analysis) and line 204 represents the CV after 10 cycle of ORR measurement. FIG. 2B depicts the ORR cycle test after the ECSA measurement for the control catalyst of line 204 reported in FIG. 2A for a total of 200 cycles. As can be seen from FIGS. 2A-2B, and particularly from FIG. 2A, the control catalyst is not quite stable as line 204 presents a significant shift in the CV curve from line 202.

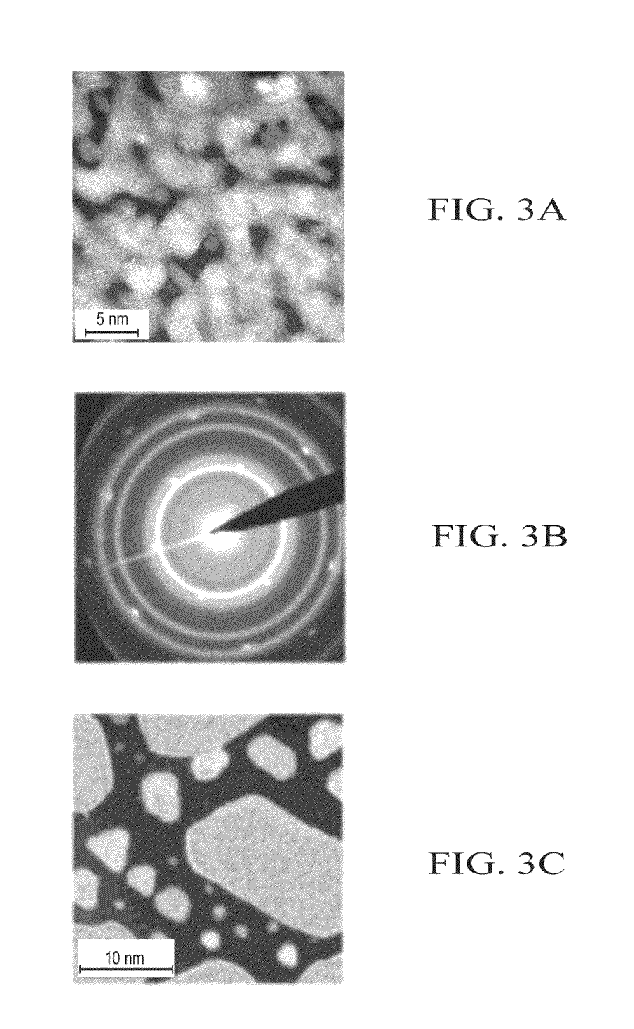

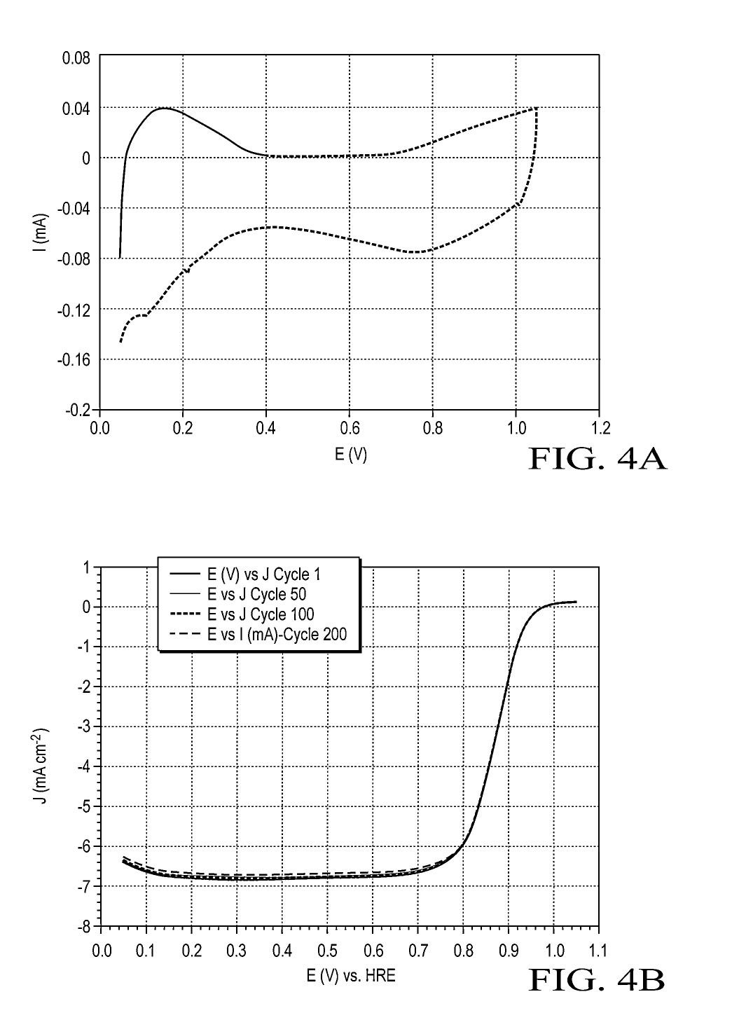

In a comparison, the sample catalyst is formed by magnetron sputtering 3.0 nm amorphous conductive NbOₓ onto the graphene at 350° C., and followed by sputtering 2.4 nm Pt onto the hybrid support of NbOₓ and graphene. FIG. 3A and FIG. 3B show the corresponding STEM (scanning transmission electron microscopy) image and the SAED (selected area electron diffraction) image of the sample catalyst, respectively. FIG. 3C shows the crystal (111) orientation of the Pt as deposited along the edge surfaces on graphene substrate. As can be seen from FIGS. 3A and 3B, a percolated Pt network is formed with the NbOₓ remains as amorphous, and the Pt polycrystalline. As can be seen from FIG. 3A, Pt atoms as deposited are in contact with both the NbOₓ coated regions and the exposed graphene regions, wherein the Pt atoms are presented with bulk-like ORR activities based on RDE measurements as shown in FIG. 4B.

FIG. 4A depicts the ECSA result of the sample catalyst referenced in FIG. 3A. FIG. 4B depicts the obtained ORR activities, indicating ORR activities in kinetic current of 2,260 μA/cm²-Pt, very close to that of the bulk-Pt, with highly acceptable stability.

Table 1 tabulates kinetic current data from duplicate runs. As reported in Table 1, kinetic current of the obtained structure with 2.4 nm Pt on NbOₓ supported on graphene is about 2,260 μA/cm².

TABLE 1

| 2.4 nm Pt on amorphous | | |
|---|---|---|
| NbOₓ supported on graphene | Roughness | Jk (μA/cm²) |
| Run 1 | 1.2 | 2143 |
| Run 2 | 0.9 | 2377 |
| Average | 1.1 | 2260 |

U.S. patent application Ser. No. ______ (with associated file docket identification of 83234077/FMC4226PUS) may be related to the method disclosed and claimed herein, and is incorporated herein by reference in its entirety.

While the best mode for carrying out the invention has been described in detail, those familiar with the art to which this invention relates will recognize various alternative designs and embodiments for practicing the invention as defined by the following claims.

What is claimed:

1. An electrochemical device comprising:
a catalyst promoter including an amorphous metal oxide, the amorphous metal oxide being of an amount greater than 50 percent by weight of the catalyst promoter; and
a substrate supporting the catalyst promoter and including graphene.

2. The electrochemical device of claim 2, further including a catalyst supported on the catalyst promoter and including a noble metal, the catalyst promoter being disposed between the catalyst and the base.

3. The electrochemical device of claim 1, wherein the catalyst contacts at least one of the amorphous metal oxide and graphene.

4. The electrochemical device of claim 2, wherein the amorphous metal oxide contacts graphene.

5. The electrochemical device of claim 2, further comprising a proton exchange membrane disposed next to the catalyst such that the catalyst is positioned between the catalyst promoter and the proton exchange membrane.

6. The electrochemical device of claim 1, wherein the amorphous metal oxide is of a general formula of MOx, with x being sub-stoichiometric relative to O such that MOx is oxygen deficient.

7. The electrochemical device of claim 1, wherein a total contacting surface between the substrate and the catalyst promoter is less than an external surface of the base.

8. The electrochemical device of claim 7, wherein the total contacting surface is 25 to 75% of the external surface of the base.

9. The electrochemical device of claim 1, wherein the catalyst promoter includes a number of spaced apart discontinuities of the amorphous metal oxide.

10. The electrochemical device of claim 9, wherein an average diameter of the number of spaced apart discontinuities is 2 to 3 nanometers.

11. An electrochemical device comprising:
a catalyst promoter including an amorphous metal oxide, the amorphous metal oxide being of an amount greater than 50 percent by weight of the substrate;
a substrate supporting the catalyst promoter and including graphene; and
a noble metal catalyst supported on the substrate, the catalyst promoter being disposed between the catalyst and the base.

12. The electrochemical device of claim 11, wherein the amorphous metal oxide contacts the graphene.

13. The electrochemical device of claim 11, wherein the amorphous metal oxide is of a general formula of MOx, with x being sub-stoichiometric relative to O such that MOx is oxygen deficient.

14. The electrochemical device of claim 11, wherein a total contacting surface between the substrate and the catalyst promoter is 25 to 75% of an external surface of the base.

15. The electrochemical device of claim 11, wherein the catalyst promoter includes a number of spaced apart discontinuities of the amorphous metal oxide, an average diameter of the number of spaced apart discontinuities being 2 to 3 nanometers.

16. A method of forming an electrochemical device, the method comprising:
forming on a substrate a catalyst promoter including an amorphous metal oxide, the substrate including graphene, the amorphous metal oxide having a general formula of MOₓ and being of greater than 50 percent by weight of the substrate; and
depositing a noble metal catalyst onto the substrate.

17. The method of claim 16, wherein the amorphous metal oxide is formed via sputtering with a source of MO_{y} and a source of an inert gas separately provided from the source of MO_{y}, y is of a value same to or different from x.

18. The method of claim 16, wherein the amorphous metal oxide is formed via sputtering with a source of neat metal M and a source of a mixed gas separately provided from the source of neat metal M, the mixed gas including oxygen and an inert gas.

19. The method of claim 17, wherein the sputtering is carried out at a temperature below a crystallization temperature of MOₓ.

20. The method of claim 17, wherein the sputtering is carried out at an oxygen-to-argon ratio of 10 to 30 percent by volume.
